(19) United States
(12) Patent Application Publication
(10) Pub. No.: US 2008/0158899 A1
(43) Pub. Date: Jul. 3, 2008

(54) COLORFUL LIGHT-EMITTING BUBBLE TYPE DECORATION FOR AUTOMOBILES

(76) Inventor: Shou-Jen Shih, Chang Hua City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/619,346

(22) Filed: Jan. 3, 2007

(51) Int. Cl. B60Q 1/00

(52) U.S. Cl. 362/489

(57) ABSTRACT

A colorful light-emitting bubble type decoration for automobiles comprises a power source device, a light emitting device, a base, a transparent housing, a cover, and a decorative tube, wherein the power source device includes a cigarette lighter plug and an adjustable flexible tube extending therefrom. In the flexible tube is disposed a wire. The light emitting device is connected to the wire of power source device and includes a LED and a heating member disposed on a circuit board. The base is fixed at an end of flexible tube, and the light emitting device is clamped in the base. The transparent housing is mounted between the cover and the base. The decorative tube is a vacuum glass tube filled with low boiling point liquid and decorative articles, and a bottom thereof abuts against the heating member of light emitting device thereby enhancing the decorative effect of the present invention.

### BACKGROUND OF THE INVENTION

1. Field of the Invention

The present invention relates to a decoration for automobiles, and more particularly to a colorful light-emitting bubble type decoration for automobiles that is provided with a colorful light source, and the decorative articles can roll up and down along with bubbles, thus creating a gorgeous decorative effect.

2. Description of the Prior Art

In recent years, with the development of society and the abundance in people's material life, every family almost has a car. Likewise, with the popularity of cars, some related electrical appliances used in automobiles are developed simultaneously, for example, a decorative light can produce soft light and improve the atmosphere and emotional appeal in a car, so it is popular and beloved by consumers. However, most conventional decorative lights can only produce monochrome light and lack vitality and variability, hence the users will find they are tedious after using a period of time, and the effect of improving the atmosphere and emotional appeal may decrease with time goes by, thus such decorative lights would be discarded wastefully.

The present invention has arisen to mitigate and/or obviate the afore-described disadvantages.

### SUMMARY OF THE INVENTION

A colorful light-emitting bubble type decoration for automobiles in accordance with the present invention comprises a power source device, a light emitting device, a base, a transparent housing, a cover, and a decorative tube. The power source device includes a cigarette lighter plug with a control switch and an adjustable flexible tube extending therefrom. In the flexible tube are enclosed a wire and a shaped reinforced linear material partially extending out of one end of the flexible tube. The light emitting device is connected to the wire of the power source device, and includes a color-changeable LED and a heating member disposed on a circuit board. The base includes a first shell and a second shell which are assembled together at one end of the flexible tube of the power source device, and the light emitting device is clamped between the first and second shells by using a fastener. The transparent housing, on which the cover is disposed, is inserted on the base, and a positioning member is received in the cover. The decorative tube is a vacuum glass tube filled with low boiling point liquid and decorative articles (such as sequins, and colorful balls), and at the bottom thereof is housed chemical deposits with micro openings. Furthermore, the decorative tube is received between the base, the transparent housing and the cover in such a manner that a bottom thereof abuts against the heating member of the light emitting device, and the top thereof is retained in the positioning member of the cover.

The primary objective of the present invention is to provide a colorful light-emitting bubble type decoration for automobiles. While in use, the LED can produce colorful lights at a fixed frequency, and the bottom of the decorative tube is heated for making the low boiling point liquid in the tube produce bubbles so as to push the decorative articles to roll along with bubbles, thereby improving vitality and variability, and providing a beautiful visual effect.

The secondary objective of the present invention is to provide a colorful light-emitting bubble type decoration for automobiles. While in use, the cigarette lighter plug of the power source device is directly plugged in the cigarette lighter, so as to adjust the present invention to any desired angle by the flexible tube, thereby achieving practical and convenient purposes.

### BRIEF DESCRIPTION OF THE DRAWINGS

FIG. 1 is an exploded view of a colorful light-emitting bubble type decoration for automobiles in accordance with the present invention;

FIG. 2 is a perspective view of the colorful light-emitting bubble type decoration for automobiles in accordance with the present invention;

FIG. 3 is a cross sectional view of the colorful light-emitting bubble type decoration for automobiles in accordance with the present invention;

FIG. 4 shows the colorful light-emitting bubble type decoration of the present invention being assembled to a car; and

FIG. 5 is an operational view of the colorful light-emitting bubble type decoration for automobiles in accordance with the present invention.

### DETAILED DESCRIPTION OF THE PREFERRED EMBODIMENTS

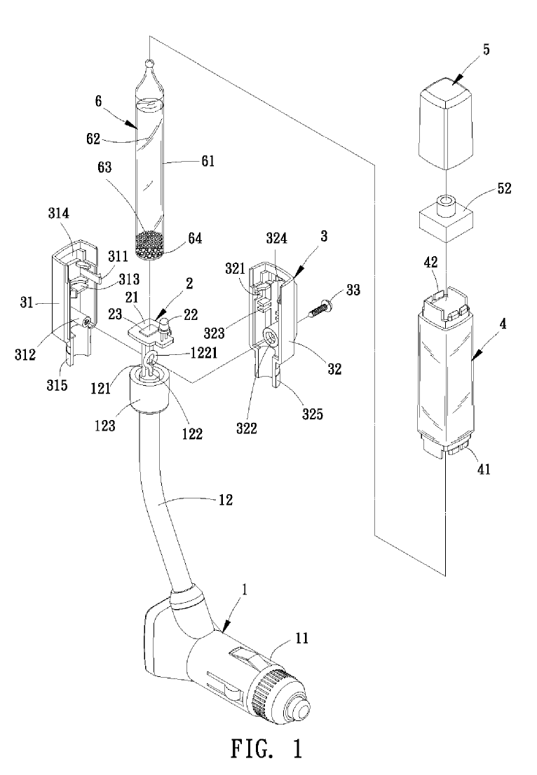

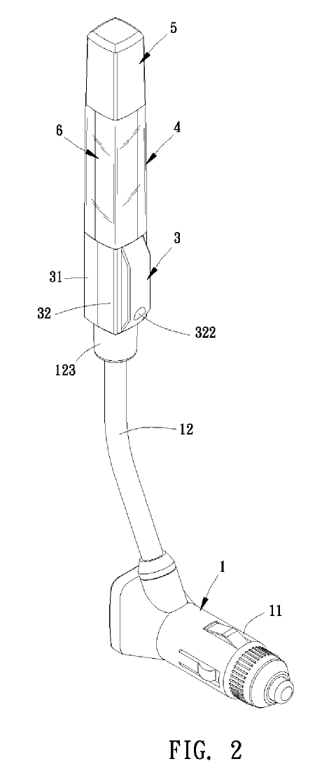

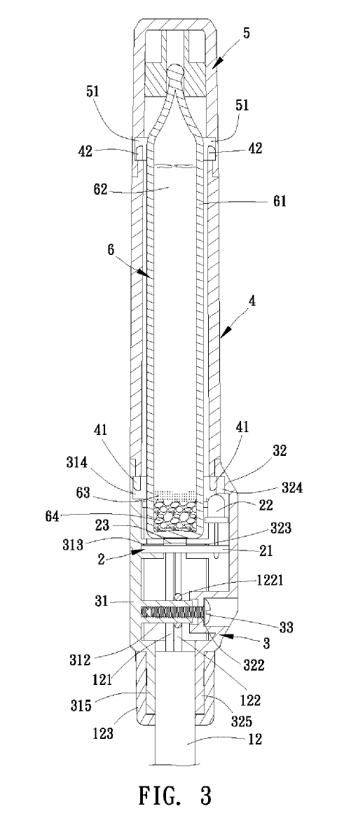

Referring to FIGS. 1-3, a colorful light-emitting bubble type decoration for automobiles in accordance with the present invention comprises a power source device 1, a light emitting device 2, a base 3, a transparent housing 4, a cover 5, and a decorative tube 6. The power source device 1 includes a cigarette lighter plug 11 with a control switch and an adjustable flexible tube 12 extending therefrom. In the flexible tube 12 are enclosed a wire 121 and a shaped reinforced linear material 122 partially extending out of one end of the flexible tube 12. At the end of the reinforced linear material 122 is arranged a ring-shaped hook 1221, and at the periphery of the end of the flexible tube 12 is attached a circular-tube-shaped connector 123. The light emitting device 2 includes a color-changeable LED 22 and a heating member 23 disposed on a circuit board 21. The heating member 23 of this preferred embodiment is a resistor. The base 3 includes a first shell 31 and a second shell 32 that are assembled together. The first shell 31 are provided in the inner surface thereof with two hooks 311, an engaging protrusion 312, a clamping slot 313 and an engaging groove 31 4, and at the lower end thereof with an inserting section 315. The second shell 32 are defined in the inner surface thereof with two engaging grooves 321, an engaging hole 322, a clamping slot 323 and an engaging groove 324, and at the lower end thereof with an inserting section 325. In addition to being made of colorless transparent material, the transparent housing 4 can also be made of light color transparent material. At one end of the transparent housing 4 are formed two opposite first engaging portions 41, while at the other end thereof are formed two opposite second engaging portions 42. The cover 5 is defined at the inner edge of the open end thereof with two opposite engaging grooves 51, and a positioning member 52 is disposed in the cover 5. The decorative tube 6 is a vacuum glass tube 61 provided with an inner space in which is filled with low boiling point liquid 62, such as Dichloromethane, and decorative articles 63, e.g., sequins, color balls and the like. In the bottom of the vacuum glass tube 61 is filled chemical deposits 64 with micro openings, such as Calcium Carbonate.

In assembly, the circuit board 21 of the light emitting device 2 is connected to the power wire 121 of the power source device 1, and the first and second shells 31, 32 of the base 3 are assembled together at the end of the flexible tube 12 of the power source device 1 in such a manner that the inserting sections 315 and 325 of the first and second shells 31, 32 are inserted in the circular-tube-shaped connector 123 at the end of the flexible tube 12, the two hooks 311 of the first shell 31 are hooked in the two engaging grooves 321 of the second shell 32, and the engaging protrusion 312 of the first shell 31 is engaged with the engaging hole 322 of the second shell 32. Meanwhile, the circuit board 21 of the light emitting device 2 is fixed between the clamping slots 31 3 and 323 of the first and second shells 31 and 32. The ring-shaped hook 1221 of the reinforced linear material 122 of the power source 1 is hooked to the engaging protrusion 312 of the first shell 31, and a fastener 33 is inserted through the engaging hole 322 of the second shell 32 and is threaded in the engaging protrusion 312 of the first shell 31. One end of the transparent housing 4 is inserted on the base 3 so that the first engaging portions 41 at this end of the transparent housing 4 are engaged in the engaging grooves 314 and 324 of the first and second shells 31, 32 of the base 3, respectively. And then the decorative tube 6 is inserted in the transparent housing 4 such that the bottom of the decorative tube 6 is abutted against the heating member 23 of the light emitting device 2. Thereafter, the cover 5 is assembled to the other end of the transparent housing 4 so that the second engaging portions 42 of the other end of the transparent housing 4 are hooked in the two engaging grooves 51 at the inner edge of the open end of the cover 5. The decorative tube 6 is received between base 3, the transparent housing 4 and the cover 5, and the top thereof is engaged with the positioning member 52 in the cover 5. Adhesive agent can be used in the abovementioned assembly process to improve the positioning effect, thus forming a color light automobile bubble decoration.

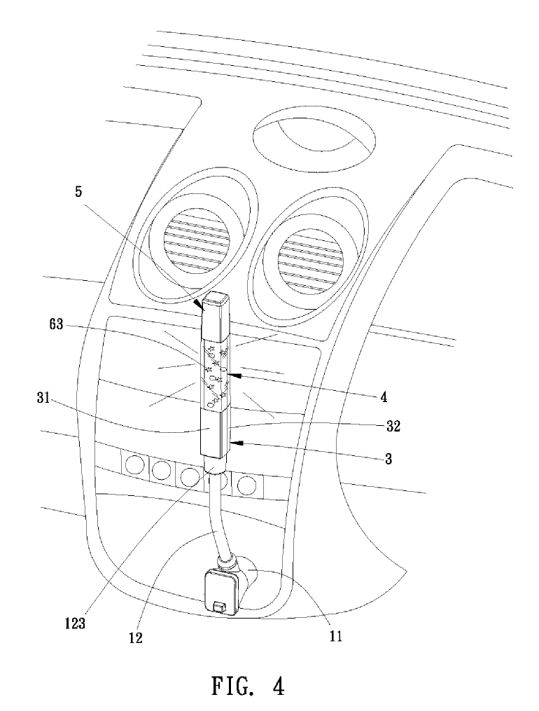

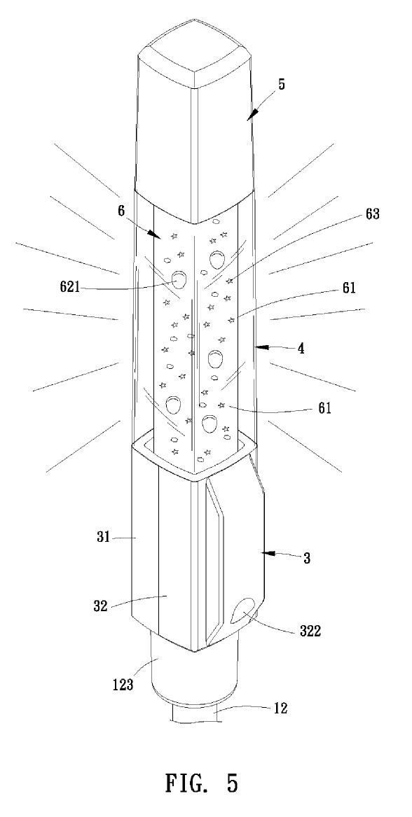

With reference to FIGS. 4 and 5, while in use, the cigarette lighter plug 11 of the power source device 1 is directly plugged in the cigarette lighter, and the colorful light-emitting bubble type decoration for automobiles in accordance with the present invention can be adjusted to any desired angle by the flexible tube 12. When the control switch of the cigarette lighter plug 11 is switched on, the power source device 1 starts providing power to the light emitting device 2, and the LED 22 is controlled by the circuit board 21 to produce colorful lights at a fixed frequency. Meanwhile, the heating member 23 is electrified and generates heat, which is transmitted to the low boiling point liquid 62 through the chemical deposits 64 at the bottom of the decorative tube 6 for making the low boiling point liquid 62 reach boiling point and continuously produce bubbles 621, along which the decorative articles 63, e.g., the sequins, the color balls, roll up and down, thus creating a gorgeous decorative effect under the light of the LED 22.

It is concluded from the abovementioned structure of the embodiment that the present invention has the following advantages:

First, while in use, the LED 22 can produce colorful lights at the bottom of the decorative tube 6 at a fixed frequency, and the heating member 23 generates heat and transmits the heat to the low boiling point liquid 62 through the chemical deposits 64 at the bottom of the decorative tube 6, making the low boiling point liquid 62 reach boiling point and continuously produce bubbles 621 for pushing the decorative articles 63, e.g., the sequins, the color balls, to roll up and down along with bubbles 621, thus improving vitality and variability, and providing a beautiful visual effect.

Second, the cigarette lighter plug 1I1 of the power source device 1 is directly plugged in the cigarette lighter, and the colorful light-emitting bubble type decoration for automobiles in accordance with the present invention can be adjusted to any desired angle by the flexible tube 12, therefore, the present invention is practical and convenient to use.

While we have shown and described various embodiments in accordance with the present invention, it is clear to those skilled in the art that further embodiments may be made without departing from the scope of the present invention.

What is claimed is:

1. A colorful light-emitting bubble type decoration for automobiles comprising:
a power source device including a cigarette lighter plug with a control switch and an adjustable flexible tube extending therefrom, in said flexible tube being enclosed a wire;
a light emitting device connected to said wire of said power source device and including a color-changeable LED and a heating member disposed on a circuit board;
a base including a first shell and a second shell assembled together at one end of said flexible tube of said power source device, and said light emitting device being clamped between said first and second shells;
a transparent housing inserted on said base;
a cover disposed on said transparent housing; and
a decorative tube received between said base, said transparent housing and said cover in such a manner that a bottom of said decorative tube is abutted against said heating member of said light emitting device, said decorative tube being a vacuum glass tube filled with low boiling point liquid and decorative articles.

2. The colorful light-emitting bubble type decoration for automobiles as claimed in claim 1, wherein a shaped reinforced linear material is disposed in said flexible tube and partially extends from one end of said flexible tube, at the end of said reinforced linear material is arranged a ring-shaped hook.

3. The colorful light-emitting bubble type decoration for automobiles as claimed in claim 1, wherein a circular-tube-shaped connector is attached to the periphery of the end of said flexible tube.

4. The colorful light-emitting bubble type decoration for automobiles as claimed in claim 1, wherein said heating member is a resistor.

5. The colorful light-emitting bubble type decoration for automobiles as claimed in claim 1, wherein two hooks, an engaging protrusion, a clamping slot and an engaging groove are formed in an inner surface of said first shell, and an inserting section is formed at a lower end of said first shell, in an inner surface of said second shell are disposed two engaging grooves, an engaging hole, a clamping slot and an engaging groove, and at a lower end of said second shell is formed an inserting section as well.

6. The colorful light-emitting bubble type decoration for automobiles as claimed in claim 1, wherein said transparent housing is colorless and transparent.

7. The colorful light-emitting bubble type decoration for automobiles as claimed in claim 1, wherein said transparent housing is light color and transparent.

8. The colorful light-emitting bubble type decoration for automobiles as claimed in claim 1, wherein two opposite engaging portions are formed at either ends of said transparent housing.

9. The colorful light-emitting bubble type decoration for automobiles as claimed in claim 1, wherein said cover is formed at an inner edge of an open end thereof with two opposite engaging grooves.

10. The colorful light-emitting bubble decoration for automobiles as claimed in claim 1, wherein a positioning member is disposed in said cover.

11. The colorful light-emitting bubble type decoration for automobiles as claimed in claim 1, wherein chemical deposits with micro openings are disposed at a bottom of said decorative tube.

12. The colorful light-emitting bubble type decoration for automobiles as claimed in claim 1, wherein said decorative articles in said decorative tube are sequins and color balls.
